(19) United States
(12) Patent Application Publication
(10) Pub. No.: US 2026/0071389 A1
(43) Pub. Date: Mar. 12, 2026

(54) METHOD FOR MANUFACTURING AN ARTICLE AT LEAST PARTIALLY MADE OF CELLULOSE FIBERS, AND ARTICLE AT LEAST PARTIALLY MADE OF CELLULOSE FIBERS

(71) Applicant: Storopack Hans Reichenecker GmbH, Metzingen (DE)

(72) Inventors: Anthony Mahé, Pont Saint Martin (FR); Charles Poisson, Cholet (FR)

(21) Appl. No.: 19/107,275

(22) PCT Filed: Sep. 5, 2022
(86) PCT No.: PCT/EP2022/074647

§ 371 Date: Feb. 27, 2025

(51) Int. Cl. D21J 3/12; B32B 5/02; B32B 7/022

(52) U.S. Cl. CPC D21J 3/12; B32B 5/02; B32B 7/022; B32B 2262/062; B32B 2307/72; B32B 2307/7376

(57) ABSTRACT

A method of manufacturing an article at least partially made of cellulose fibers comprises inserting a cellulose pulp comprising cellulose fibers and water into a mixing cavity; applying a high shear mixing action to the cellulose pulp using a high-shear mixer, such that a foam blend comprising cellulose fibers, water and air bubbles is created; inserting the foam blend into a mold cavity; and molding the article by heating the foam blend contained within the mold cavity.

The present invention relates to a method for manufacturing an article at least partially made of cellulose fibers, and to an article at least partially made of cellulose fibers, according to the preambles of the independent claims.

WO 2021/262467 A1 discloses a protective packaging and methods of making the same. More specifically, it discloses to produce a foam made of wood fibers, a binder, a surfactant, and water. The foam is introduced into an oven and heated using microwaves. EP 2 841 649 B1 relates to a fibrous web of paper using a foam comprising water and cellulose fibers.

It is an object of the present invention to provide a method for manufacturing an article at least partially made of cellulose fibers and to provide an article at least partially made of cellulose fibers, the article having a three dimensional shape and a low weight.

This object is achieved by means of a method for manufacturing an article at least partially made of cellulose fibers and by an article at least partially made of cellulose fibers having the features of the independent claims. Further embodiments are given in the dependent claims.

The method according to the invention allows to produce an article comprising an inner core portion and an outer skin portion, wherein the density of the cellulose fiber material in the inner core portion is lower than the density of the cellulose fiber material in the outer skin portion. Such an article therefore has a relatively high stiffness of the outer skin portion, but at the same time a relatively low density of the inner core portion. The term “low density” of the inner core portion encompasses both a zero density (i.e. a void) and a density which is not zero but significantly lower than that of the outer skin portion. In sum, the article according to the invention has a relatively low weight. Furthermore, since the article is molded, it has a defined and desired three dimensional shape.

The article produced by means of the inventive method is further characterized by an improved softness of the surface created by the low density which prevents a sensitive product from being scratched during its transport. Furthermore, with the inventive method the cycle time need to produce an article is lower compared to prior art methods. Finally, the inventive method allows to produce an article having portions which are relatively thick and other portions which are relatively thin, and all this in the same manufacturing process. By way of example, the thickness may vary by a factor of 5, more preferably by a factor of 10 in the same article.

More specifically, the invention proposes a method for manufacturing an article made of cellulose fibers. By way of example, the cellulose fibers may be obtained from paper, preferably from used paper. It is to be noted that the term “paper” comprises carton, cardboard, and the like, and may be a product made from an assembly of natural fibers, such as softwood, hardwood, flax fibers, hemp fibers, and cotton, wherein fibers of different lengths may be mixed. Preferably, the paper is provided in the form of paper sheets. The method comprises as a first step inserting a cellulose pulp comprising cellulose fibers and water into a mixing cavity, e.g. a mixing volume or mixing receptacle. The cellulose pulp may be obtained by a previous pulping step wherein the above mentioned paper sheets are combined with a high amount of water to separate the fibers from each other such that a cellulose pulp slurry (“cellulose pulp”) is created.

In a subsequent step of the inventive method, a high shear mixing action is applied to the cellulose pulp using a high-shear mixer. Such a high-shear mixer may, by way of example, comprise an outer fixed cylindrical stator and an inner rotatable rotor. The outer surface of the rotor is very close to the inner surface of the stator with only a very small radial gap between both surfaces, and the rotor is turning with a very high rotational speed. This leads to a high shear action exercised to the cellulose pulp between the inner surface of the stator and the outer surface of the rotor. The application of the high shear mixing action creates a foam blend comprising cellulose fibers, water and air bubbles.

High shearing is very important to create the dispersion of the fibers in the foam and to obtain finally a fiber network. A high intensity of energy is required to overcome the adhesion forces between the cellulose fibers. This high energy input may be best provided by a high shear mixer.

In a further subsequent step of the inventive method, the foam blend is inserted into a mold cavity. This method step may be similar to method steps known from other molding technologies, e.g. injection molding, wherein injection nozzles are provided in a wall of the mold in order to inject the foam blend into the mold cavity.

In a further subsequent step of the inventive method, the article is molded by heating the foam blend contained within the mold cavity. Again, this method step may be similar to known molding methods. For example, heat may be applied to the foam blend by heating the mold surfaces of the mold, and/or by blowing a hot gas into the mold cavity. The object of the heating step is mainly to remove any remaining liquid water and humidity from the foam blend, such that the cellulose fibers may adhere to each other mainly by natural hydrogen bonding. This creates a solid, dry, and three dimensional molded body at least partially made of cellulose fibers.

In a further embodiment, prior to or during step d (heating step) the water is at least partially drained from the foam blend. This reduces the amount of water within the foam blend contained inside the cavity. Only a minimum amount of water is kept allowing to keep the water film around the air bubbles of the foam. By doing so, the final quality of the article is improved.

In a further embodiment hereto, the water is partially drained through at least a portion of a wall surrounding the mold cavity. For example, a multitude of drain holes may be provided in the wall which are large enough to allow the water to pass and which are small enough to prevent the cellulose fibers from entering. Preferably, the drain holes are provided in a bottom portion of the mold such that the water may be drained by gravity. This further embodiment significantly reduces the amount of water that must be removed in the form of steam in a later step of the manufacturing process, thereby reducing the energy required to produce the article and the cycle time. However, it is understood that in most applications, the water contained in the foam cannot be completely removed by draining and therefore there is a need to remove the remaining water and moisture in the form of steam by heating, which also requires a gas-permeable mold wall. It is understood that the drain holes may also be located on the side of the mold, for example, in the event that the mold is rotated about an axis of rotation, resulting in a centrifugal force that causes the water to exit the mold cavity in the direction of the centrifugal forces.

In a further embodiment, a gas pressure difference between the inside of the mold cavity and a volume which is outside of the mold cavity is controlled at least temporarily. Preferably, the gas pressure difference is of the type wherein the gas pressure inside the mold cavity is higher than the gas pressure outside the mold cavity. This may be achieved by applying an overpressure inside the mold cavity or by applying a suction outside the mold cavity. This suction may be applied, by way of example, through the above mentioned drain holes in the wall of the mold.

This type of pressure difference helps to drain remaining water and pushes the cellulose fiber material towards the wall of the mold such that the density of the material close to the wall of the mold becomes higher than distant from the wall of the mold. This leads to a final article comprising an inner core portion and an outer skin portion, wherein the density of the cellulose fiber material in the inner core portion is lower than the density of the cellulose fiber material in the outer skin portion.

In a further embodiment hereto, a gas permeability of a first wall portion of the mold cavity is different to a second wall portion. For example, a number of venting holes per surface area in the wall of the mold may be different from one wall portion to another wall portion. This allows to manufacture an article having a density of a first region of the outer skin portion which is different to a density of a second region of the outer skin portion.

In a further embodiment, an object is inserted into the mold cavity prior to step d, which includes that the object may be inserted prior to step c. This object may be, by way of example, a plastic film (e.g. comprising PE), e.g. in the form of a plastic bag, which is gas and/or liquid tight. This allows to manufacture an article comprising a gas and/or liquid tight cavity and an outer wall made of cellulose fibers and having a cushioning capacity. By way of another example, the object may be an article to be transported and to be protected by the cellulose fiber article from environmental hazards, for example mechanical shocks. The article made of cellulose fibers therefore contains the article to be transported.

In a further embodiment, the foam blend contained within the mold cavity is heated by high frequency electromagnetic radiation. This is a very efficient method to heat the foam blend without a necessity to insert a hot gas or steam into the mold cavity. Heating by electromagnetic radiation is possible with the inventive methods since even after the above mentioned draining step the foam blend still contains enough humidity to allow heating by electromagnetic radiation (e.g. microwaves). Furthermore, it has been observed that drying a foam of pulp with high frequency makes the bubbles in the core of the material to expand. By consequence, the cellulose fibers are pushed against the permeable surfaces of the mold.

In a further embodiment, prior to or during step b (high shear mixing) a surfactant, pigments, and/or an additive, e.g. influencing thermal property, is added to the cellulose pulp. This allows to design and adapt the cellulose pulp to the specific needs of the article to be manufactured. More specifically, the article may obtain a desired color and/or a desired thermal insulation property. Furthermore, a surfactant may lower the surface tension of the water and thus lower the internal cohesion of the water. This allows to adjust the physical properties of the foam to the requirements of the specific application. Another additive might improve the bonding between the fibers. Another additive can migrate to the surface to create a soft touch. An advantage of the proposed technology is the ability to mix short fibers with longer fibers. The short fibers migrate to the surface to provide a soft touch, while the longer fibers provide the desired mechanical properties with efficient entanglement of the fibers.

In a further embodiment, the mold at least regionally has an elevated temperature when the foam blend is inserted. This helps to create an outer skin portion at the molded article having a much higher density than an inner core portion. Furthermore, this helps to remove liquid water from the foam blend.

As already mentioned above, the invention allows to manufacture an article made of a non-woven cellulose fiber material, comprising a an inner core portion and an outer skin portion, wherein the density of the cellulose fiber material in the inner core portion is lower than the density of the cellulose fiber material in the outer skin portion.

With such an article, a density gradient in a transient region between the core portion and the skin portion is preferably lower than approx. 5000 kg/m³. cm, preferably lower than approx. 1500 kg/m³. cm. This means that the density of the article produced according to the present invention provides a rather smooth change of density from the inner core portion to the outer skin portion. This increases the overall stability of the inventive article and provides superior cushioning properties.

In a further embodiment, a density of a first region of the outer skin portion is different to a density of a second region of the outer skin portion. As mentioned above, this can be achieved by having a mold having different gas permeabilities seen in lateral direction. An article with these features thus has skin portions adjacent to each other which have different densities and therefore different stiffness and/or different haptic properties.

In a further embodiment, the article comprises a film material. In a further embodiment hereto, the film material forms a closable or closed cavity inside the article. As mentioned above, such an article therefore may form a sort of bottle or receptacle having an outer soft cushioning wall.

In a further embodiment, a thickness of the outer skin portion is at least 5 mm. The inventive article and method therefore may have a rather large thickness of the outer skin which provides a superior stability.

Embodiments of the invention now will be described with reference to the attached drawing. In the drawing show

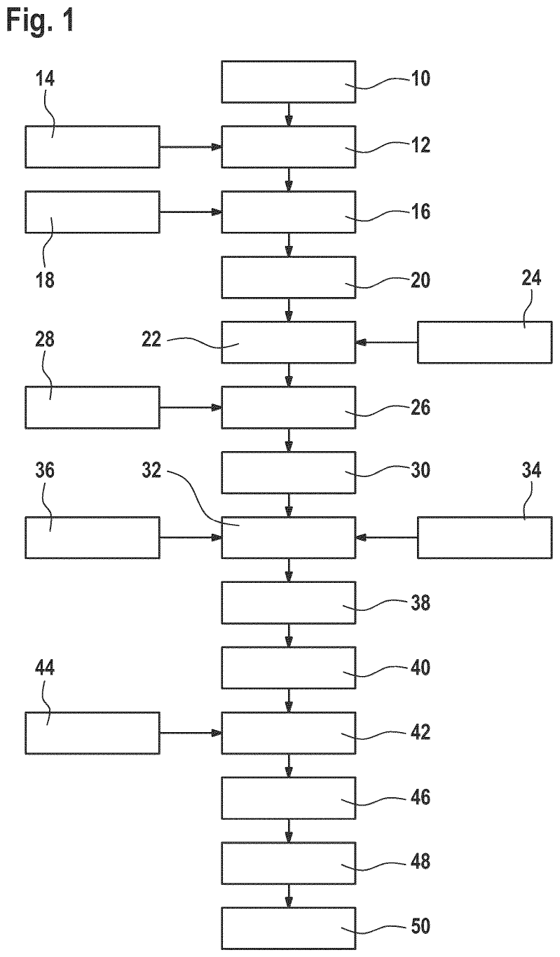

FIG. 1 a flowchart of a method for manufacturing an article at least partially made of cellulose fibers;

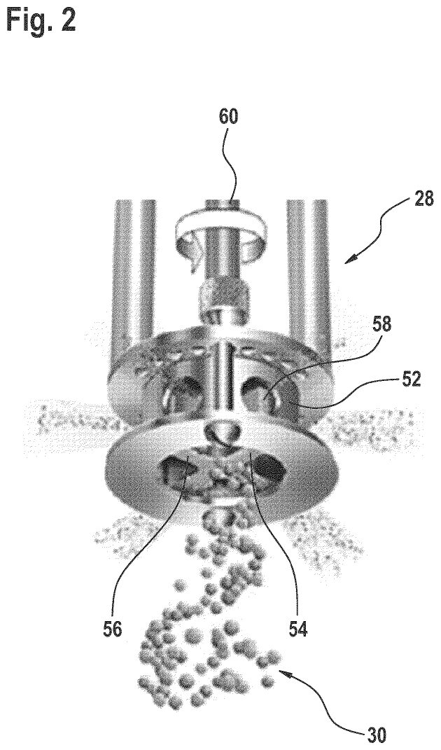

FIG. 2 a schematic representation of a high shear mixing device used in the method of FIG. 1;

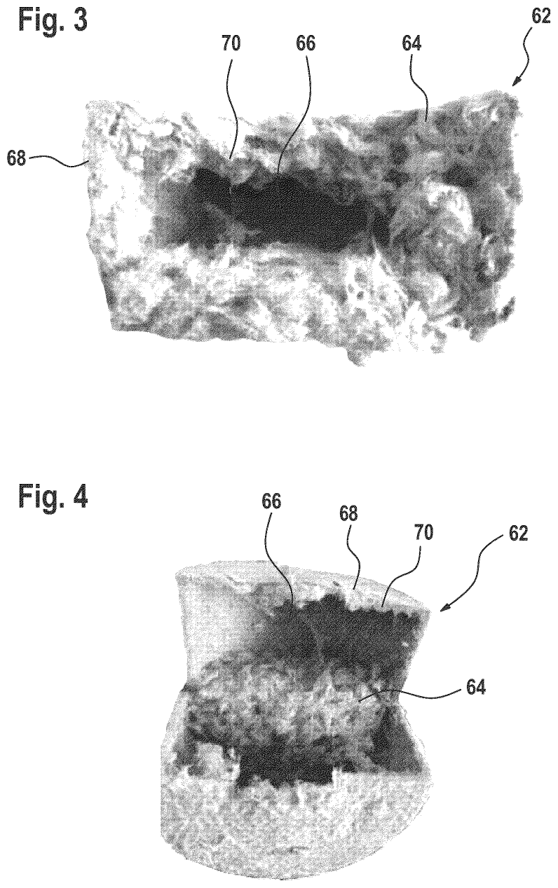

FIG. 3 a front view into a first embodiment of an article manufactured with the method of FIG. 1;

FIG. 4 a view similar to FIG. 3 of a second embodiment of an article;

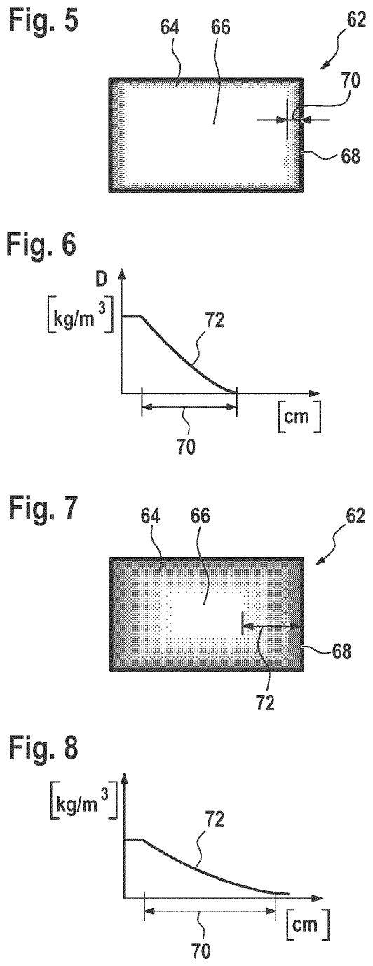

FIG. 5 a schematic sectional side view of the article of FIG. 4;

FIG. 6 a diagram showing the density of the article of FIG. 4 along its lateral extension;

FIG. 7 a schematic sectional side view of the article of FIG. 3;

FIG. 8 a diagram showing the density of the article of FIG. 3 along its lateral extension;

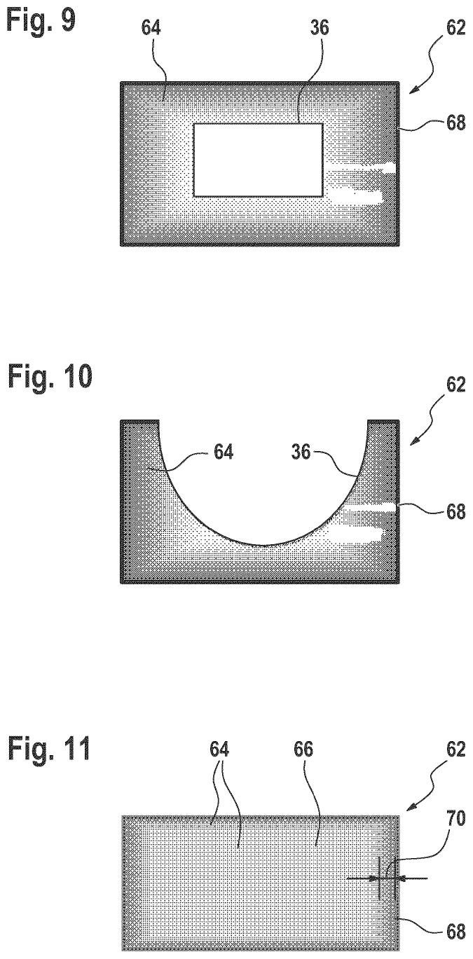

FIG. 9 a schematic sectional side view of a further embodiment of an article;

FIG. 10 a schematic sectional side view of a further embodiment of an article; and

FIG. 11 a schematic sectional side view of a further embodiment of an article.

Hereinafter, functionally equivalent elements and portions will be denoted with the same reference numerals in different embodiments and figures.

A method for manufacturing an article made of cellulose fibers starts in a start block 10. In a functional block 12, cellulose fibers and water, which are provided in a functional block 14, are brought together in order to form an initial cellulose pulp. In a functional block 16, the initial cellulose pulp is refined by adding other components, such as, by way of example, a surfactant, pigments and/or an additive, the latter for example influencing the thermal properties of the cellulose pulp. These other components are provided in a functional block 18. As a result of the refining step in block 16, a cellulose pulp slurry is obtained in functional block 20.

In a subsequent functional block 22, the pulp 20 is inserted into a mixing cavity, which is provided in a functional block 24. Thereafter, a high shear mixing action is applied to the cellulose pulp 20 in a functional block 26, using a high shear mixer which is provided in a functional block 28. By means of this high shear mixing action one obtains in functional block 30 a foam blend comprising cellulose fibers, water and air bubbles.

Subsequently, in a functional block 32, the foam blend 30 is inserted into a mold cavity, the latter being provided in a functional block 34. Optionally, prior to inserting the foam blend 30 into the mold cavity 34, an object might have been inserted into the mold cavity 34, such an object being provided in functional block 36. The object might be an object to be protected by the article made of cellulose fibers, or may comprise a gas and/or fluid tight plastic film, for example in the form of a bag, forming an inner surface of a cavity. The plastic film may be solid/rigid in order to provide a defined shape of the cavity.

Subsequently, liquid water contained in the foam blend 30 is drained in functional block 38. Preferably, the water is drained at least initially by gravity. In order to allow the water to be drained by gravity, a wall of the mold may comprise a plurality or a multitude of drain openings which are large enough to allow the water to pass, but which are small enough in order to prevent the cellulose fibers from entering. The drain openings are arranged preferably in a lower part of the mold.

In a functional step 40, a gas pressure difference between the inside of the mold cavity 34 and the outside of the mold cavity 34 is applied at least temporarily. By way of example, an underpressure or a suction may be applied outside of the mold cavity 34 such that, on the one hand, the water is sucked out from the mold cavity 34, and, on the other hand, cellulose fibers inside the mold cavity 34 move towards the inner wall of the mold cavity 34 and are pressed against the inner wall of the mold cavity 34. A gas permeability of a first wall portion of the mold cavity 34 may be different to a second wall portion. The gas permeability may be provided at least partially by the above mentioned drain openings.

In a functional step 42, the foam blend 30 inside the mold cavity 34 is heated by applying high frequency electromagnetic radiation, for example microwaves. The high frequency electromagnetic radiation is provided in a functional block 44. It is to be understood that the material of the wall of the mold must be selected such that it can be penetrated by the high frequency electromagnetic radiation.

The heating step 42 raises the temperature of the foam blend 30 inside the mold cavity 34 which makes the water in the foam blend 30 to vaporize and to exit the mold cavity 34 by the above mentioned drain openings. This leads to a drying step 46 wherein the cellulose fibers adhere to each other mainly by hydrogen bonding. Finally, the mold is opened in functional block 48, and the method ends in functional block 50.

FIG. 2 shows the high shear mixing device which is provided in the above-mentioned functional block 28 in more detail. In the present exemplary embodiment, the high shear mixing device 28 may comprise an outer fixed cylindrical stator 52 and an inner rotatable rotor 54. The rotor 54 comprises a plurality of the radially extending rotor blades 56. A radially outer surface 58 of the rotor blades 56 is very close to an inner surface of the stator 52 with only a very small radial gap between both surfaces. The rotor 54 is turning around a rotational axis 60 with very high rotational speed. This leads to a high shear action exercised to the cellulose pulp 20 inside the mentioned gap and creates the above mentioned foam blend 30 comprising cellulose fibers, water and air bubbles.

An article 62 which is obtained by the method described in FIG. 1 may be of the type shown either in FIG. 3 or in FIG. 4. The article 62 is at least partially made of cellulose fibers 64, and it comprises an inner core portion 66 and an outer skin portion 68. A density of the material formed by the cellulose fibers 64 in the inner core portion 66 is lower than the density of the material formed by the cellulose fibers 64 in the outer skin portion 68.

In the article 62 of FIG. 3, the outer skin portion 68 has a relatively large thickness, which may be 5 mm or more. In those embodiments of FIGS. 3 and 4, the density of the material formed by the cellulose fibers 64 in the inner core portion 68 is very low, for example close to zero. Or, in other words: in the inner core portion 68 of the articles 64 of FIGS. 3 and 4, nearly no material formed by the cellulose fibers 64 is present. However, there might be a transient region 70 between the inner core portion 66 and the outer skin portion 68, and within this transient region 70 the density of the material formed by the cellulose fibers 64 gradually increases from the inner core portion 66 to the outer skin portion 68.

As is schematically shown for the embodiment of FIG. 5, a thickness of the outer skin portion 68 is rather low, for example some tenth of millimeters, and the thickness of the transient region 70 might be equally rather low, for example some millimeters. In this case, a density gradient 72 (FIG. 6) in the transient region 70 may be in the order of magnitude between 1000 and 2000 kg/m³·cm, that is lower than approx. 5000 kg/m³·cm, preferably lower than approx. 1500 kg/m³·cm, e.g. 1200 kg/m³·cm.

For the embodiment of FIG. 7, a thickness of the transient region 70 is rather high, compared to the transient region 70 of FIG. 5. By consequence, a density gradient 72 (FIG. 8) in the transient region 70 may be in the order of magnitude between 100 and 500 kg/m³·cm, e.g. 200 kg/m³·cm.

In the method of FIG. 1 a functional block 32 was described where an object 36 was inserted into the mold cavity 34 prior to inserting the foam blend 30. FIG. 9 represents an example for a finally molded article 62 made of cellulose fibers 64 and comprising an object 36. The object 36 in this embodiment is entirely surrounded by the article 62 and therefore protected by the article 62 against mechanical shocks, as they may occur for example during a transport of the object 36 and the article 62. When the object 36 arrives at its destination, the article 62 made of cellulose fibers 64 may easily be destroyed/opened in order to remove the article 62 from its enclosure.

In the embodiment of FIG. 10, the object 36 is formed by a plastic film in the form of a solid/rigid half sphere.

In the embodiment of FIG. 11, which is similar to that of FIG. 5, also the inner core portion 66 comprises a substantial amount of cellulose fibers 64 and therefore has a density which is substantially greater than zero.

1. A method for manufacturing an article at least partially made of cellulose fibers, the method comprising the following steps:
a. inserting a cellulose pulp comprising cellulose fibers and water into a mixing cavity (24);
b. applying a high shear mixing action to the cellulose pulp using a high-shear mixer, such that a foam blend comprising cellulose fibers, water and air bubbles is created;
c. inserting the foam blend into a mold cavity; and
d. molding the article by heating the foam blend contained within the mold cavity.

2. The method of claim 1, wherein prior to or during step d the water is at least partially drained from the foam blend.

3. The method of claim 2, wherein the water is partially drained through at least a portion of a wall of the mold cavity.

4. The method of claim 1 wherein a gas pressure difference between the inside of the mold cavity and the outside of the mold cavity is applied at least temporarily.

5. The method of claim 4, wherein a gas permeability of a first wall portion of the mold cavity is different to a second wall portion.

6. The method of claim 1 wherein an object is inserted into the mold cavity prior to step d.

7. The method of claim 1 wherein the foam blend contained within the mold cavity is heated by electromagnetic radiation, preferably by high frequency electromagnetic radiation.

8. The method of claim 1 wherein prior to or during step b a surfactant, pigments, and/or an additive influencing thermal property is added to the cellulose pulp.

9. The method of claim 1 wherein a mold at least regionally has an elevated temperature when the foam blend is inserted.

10. An article at least partially made of cellulose fibers, comprising an inner core portion and an outer skin portion, wherein the density of the material formed by the cellulose fibers in the inner core portion is lower than the density of the material formed by the cellulose fibers in the outer skin portion.

11. The article of claim 10, wherein a density gradient in a transient region between the inner core portion and the outer skin portion is lower than approximately 5000 kg/m³.cm.

12. The article of claim 10, wherein a density of a first region of the outer skin portion is different than a density of a second region of the outer skin portion.

13. The article of claim 10, wherein it comprises an object comprising a film material.

14. The article of claim 13, wherein the film material forms a closable or closed cavity inside the article.

15. The article of claim 10, wherein a thickness of the outer skin portion is at least 5 mm.

16. The article of claim 10, wherein a density gradient in a transient region between the inner core portion and the outer skin portion is lower than approximately 1500 kg/m³.cm.
